(19) United States
(12) Patent Application Publication
(10) Pub. No.: US 2026/0285230 A1
(43) Pub. Date: Sep. 24, 2026

(54) Vehicle Safety Assembly

(71) Applicants: Abderrahim Hayal, Fuquay Varina, NC (US); Nora Hayal, Fuquay Varina, NC (US)

(72) Inventors: Abderrahim Hayal, Fuquay Varina, NC (US); Nora Hayal, Fuquay Varina, NC (US)

(21) Appl. No.: 19/083,715

(22) Filed: Mar. 19, 2025

(51) Int. Cl. B60R 1/08; B60R 1/12; B60R 1/25; B60R 1/26

(52) U.S. Cl. CPC B60R 1/081; B60R 1/25; B60R 1/26; B60R 2001/1253

(57) ABSTRACT

A vehicle safety assembly for revealing objects in a blind spot of a vehicle includes a screen and a camera. The screen is selectively engageable to a sidemirror of a vehicle so that the screen overlays a portion of and is mounted to the sidemirror. The camera is selectively engageable to a respective opposed side of the vehicle upon which the sidemirror is positioned. The camera is mounted to the vehicle and positioned to capture a video image of a blind spot of the vehicle. The camera is operationally engaged to the screen and is positioned to communicate the video image to the screen. The screen displays the video image to a driver of the vehicle, enabling the driver to view objects in the blind spot.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIE TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to safety assemblies and more particularly pertains to a new safety assembly for revealing objects in a blind spot of a vehicle. The present invention discloses a safety assembly comprising a camera mountable to a side of a car and a screen mountable to a sidemirror positioned on the side of the car.

### (2) Description of Related Art including information disclosed under 37 CFR 1.97 and 1.98.

The prior art relates to safety assemblies. Prior art safety assemblies may comprise camera and screen combinations wherein images of blind spots are displayed on screens viewable by drivers, such screens positioned in passenger compartments, sidemirrors. The cameras, which generally are mounted on sidemirrors or rear bumpers, may be operationally engaged to and actuated by sensors or turn signals. What is lacking in the prior art is a safety assembly comprising a camera mountable to a side of a car and a screen mountable to a sidemirror positioned on the side of the car.

### (h) BRIEF SUMMARY OF THE INVENTION

An embodiment of the disclosure meets the needs presented above by generally comprising a screen and a camera. The screen is selectively engageable to a sidemirror of a vehicle so that the screen overlays a portion of and is mounted to the sidemirror. The camera is selectively engageable to a respective opposed side of the vehicle upon which the sidemirror is positioned. The camera is mounted to the vehicle and positioned to capture a video image of a blind spot of the vehicle. The camera is operationally engaged to the screen and is positioned to communicate the video image to the screen. The screen is configured to display the video image to a driver of the vehicle, enabling the driver to view objects in the blind spot.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a vehicle safety assembly according to an embodiment of the disclosure.

FIG. 2 is a front view of an embodiment of the disclosure.

FIG. 3 is an in-use view of an embodiment of the disclosure.

FIG. 4 is an in-use view of an embodiment of the disclosure.

FIG. 5 is a front view of an embodiment of the disclosure.

### (j) DETAILED DESCRIPTION OF THE INVENTION

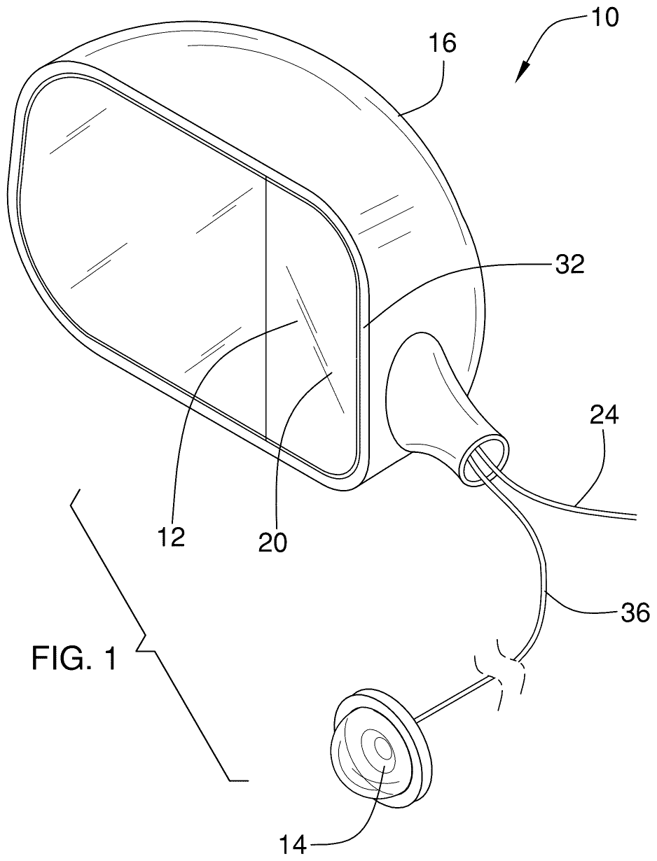

With reference now to the drawings, and in particular to FIGS. 1 through 5 thereof, a new safety assembly embodying the principles and concepts of an embodiment of the disclosure and generally designated by the reference numeral 10 will be described.

As best illustrated in FIGS. 1 through 5, the vehicle safety assembly 10 generally comprises a screen 12 and a camera 14. The screen 12 is selectively engageable to a sidemirror 16 of a vehicle 18 so that the screen 12 overlays a portion 20 of and is mounted to the sidemirror 16. Engagement of the screen 12 to the sidemirror 16 can be achieved using well-known adhesive techniques.

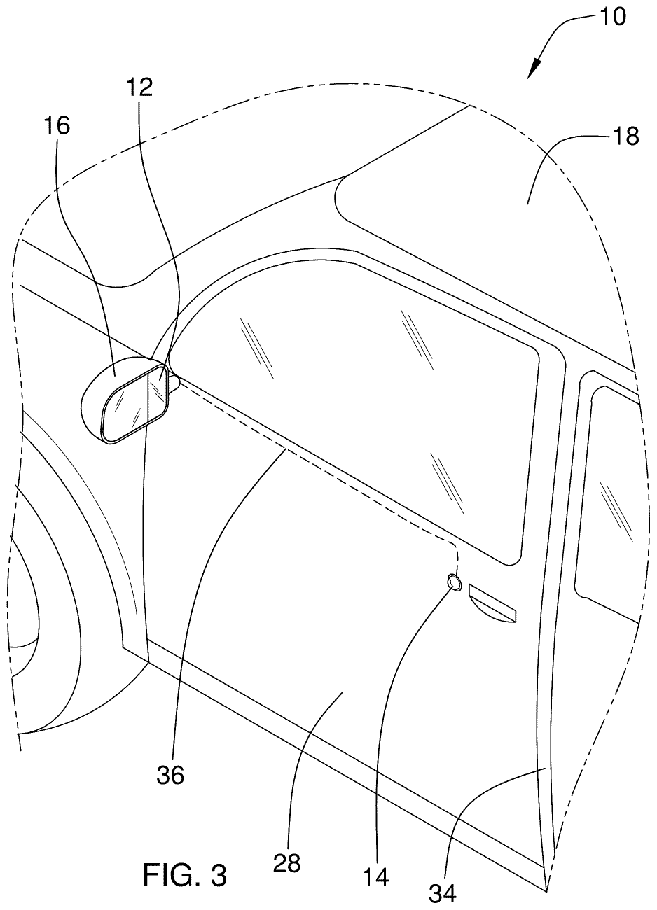

The screen 12 is selectively operationally engageable to a turn signal apparatus 22 of the vehicle 18 so that the screen 12 is actuated concurrently with the turn signal apparatus 22. As shown in FIG. 3, a first wire 24 operationally engages the screen 12 to the turn signal apparatus 22.

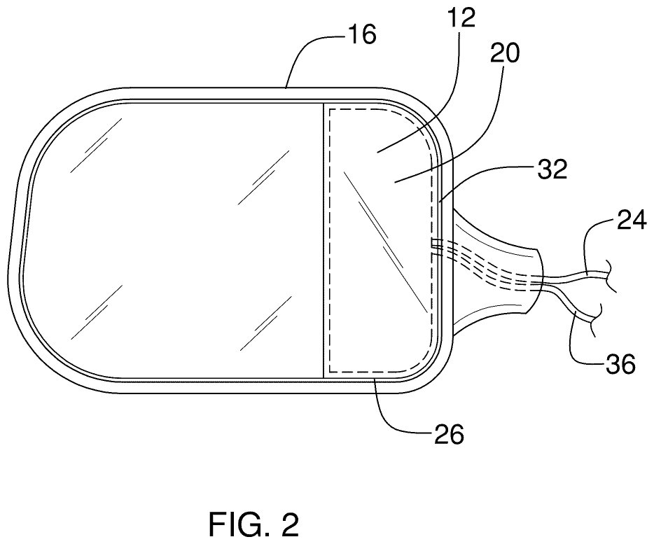

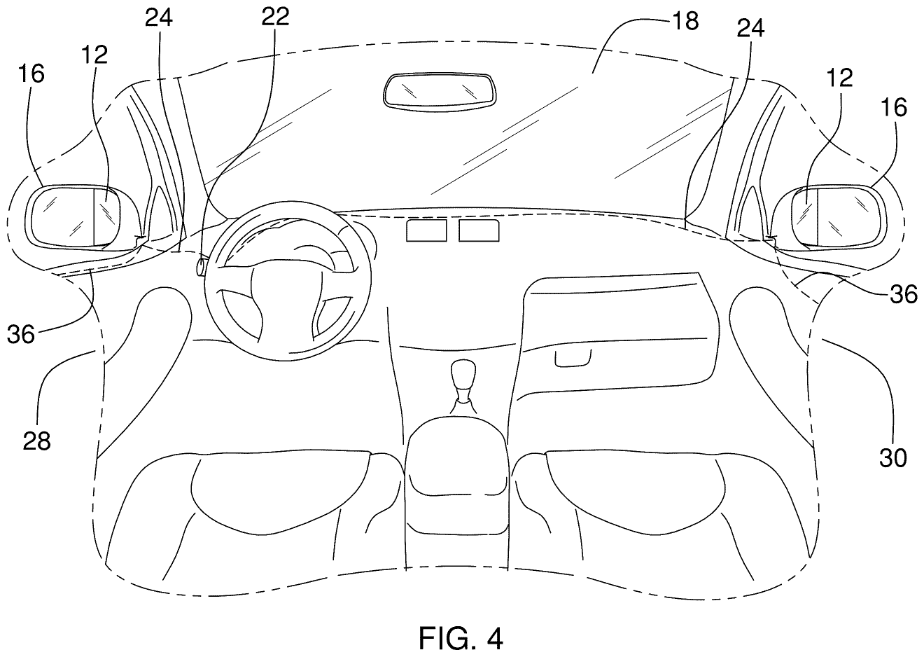

As shown in FIG. 2, the screen 12 may be configured to be engageable to the sidemirror 16 so that the portion 20 of the sidemirror 16 overlaid by the screen 12 is adjacent a side edge 32 of the sidemirror 16 and proximate to an associated opposed side 34 of the vehicle 18. The configuration shown in FIG. 2 would be appropriate for use with a driver's sidemirror 16 of a passenger vehicle 18. As shown in FIG. 4, each of a pair of screens 12 is engageable singly to a sidemirror 16 positioned on a driver's door 28 and a sidemirror 16 positioned on a front passenger door 30 of the vehicle 18.

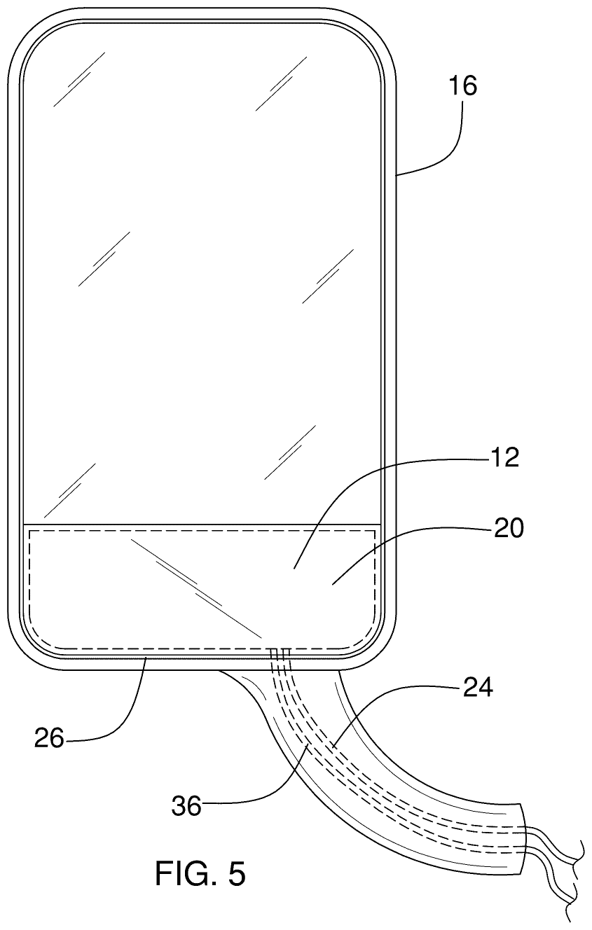

As shown in FIG. 5, the screen 12 also may be configured to be engageable to the sidemirror 16 so that the portion 20 of the sidemirror 16 overlaid by the screen 12 is adjacent to a bottom edge 26 of the sidemirror 16. The configuration shown in FIG. 5 would be appropriate for use with a driver's door 28 sidemirror 16 of a truck (not shown).

The camera 14 is selectively engageable to a respective opposed side 34 of the vehicle 18 upon which the sidemirror 16 is positioned, as shown in FIGS. 3 and 4. Engagement of the camera 14 to the respective opposed side 34 of the vehicle 18 can be achieved using well-known adhesive techniques, magnets, and the like. The camera 14 thus mounted to the vehicle 18 is positioned to capture a video image of a blind spot of the vehicle 18.

The camera 14 is operationally engaged to the screen 12 and is positioned to communicate the video image to the screen 12. The screen 12 is configured to display the video image to a driver of the vehicle 18, enabling the driver to view objects in the blind spot. The present invention is anticipated to reduce impacts with objects in blind spots of vehicles 18, thus reducing potential for injury and damage.

The camera 14 is configured to be engaged to the driver's door 28 or the front passenger door 30 of the vehicle 18, as shown in FIG. 3. The camera 14 also may comprise a pair of cameras 14 configured to be engaged singly to the driver's door 28 and the front passenger door 30, as would be the case for the configuration shown in FIG. 4.

The camera 14 is one or both of wiredly and wirelessly connected to the screen 12. As shown in FIGS. 3 and 4, the camera 14 is wiredly engaged to the screen 12 by a second wire 36. Wireless connection of the camera 14 to the screen 12 is achievable by means well known to those skilled in the art of wireless communication and could comprise transmitters, transceivers, microprocessors, and the like.

In use, the screen 12 is engaged to the sidemirror 16 and the camera 14 is engaged to the driver's door 28 of the vehicle 18. When the turn signal apparatus 22 is actuated, so too is the camera 14, enabling it to capture the video image of the blind spot and to communicate the video image to the screen 12 for display to the driver of the vehicle 18, enabling the driver to view objects in the blind spot.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle safety assembly comprising:
a screen selectively engageable to a sidemirror of a vehicle, such that the screen overlays a portion of and is mounted to the sidemirror; and
a camera selectively engageable to a respective opposed side of the vehicle upon which the sidemirror is positioned, such that the camera is mounted to the vehicle and positioned for capturing a video image of a blind spot of the vehicle, the camera being operationally engaged to the screen, such that the camera is positioned for communicating the video image to the screen, wherein the screen is configured for displaying the video image to a driver of the vehicle, enabling the driver to view objects in the blind spot.

2. The vehicle safety assembly of claim 1, wherein the screen is selectively operationally engageable to a turn signal apparatus of the vehicle, such that the screen is actuated concurrently with the turn signal apparatus.

3. The vehicle safety assembly of claim 1, wherein the screen is configured to be engageable to the sidemirror such that the portion of the sidemirror overlaid by the screen is adjacent to a bottom edge of the sidemirror or to a side edge of the sidemirror proximate to an associated opposed side of the vehicle.

4. The vehicle safety assembly of claim 2, wherein:
the camera is one or both of wiredly and wirelessly connected to the screen; and
the screen is wiredly connected to the turn signal apparatus.

5. The vehicle safety assembly of claim 4, further including:
a first wire operationally engaging the screen to the turn signal apparatus; and
a second wire operationally engaging the camera to the screen.

6. The vehicle safety assembly of claim 1, wherein the camera is configured to engage a driver's door or a front passenger door of the vehicle.

7. A vehicle safety system comprising:
a vehicle having a sidemirror engaged to a respective opposed side thereof;
a screen engaged to the sidemirror, such that the screen overlays a portion of and is mounted to the sidemirror; and
a camera engaged to the respective opposed side of the vehicle upon, such that the camera is mounted to the vehicle and positioned for capturing a video image of a blind spot of the vehicle, the camera being operationally engaged to the screen, such that the camera is positioned for communicating the video image to the screen, wherein the screen is configured for displaying the video image to a driver of the vehicle, enabling the driver to view objects in the blind spot.

8. The vehicle safety system of claim 7, wherein the screen is operationally engaged to a turn signal apparatus of the vehicle, such that the screen is actuated concurrently with the turn signal apparatus.

9. The vehicle safety system of claim 7, wherein the screen is engaged to the sidemirror such that the portion of the sidemirror overlaid by the screen is adjacent to a bottom edge of the sidemirror or to a side edge of the sidemirror proximate to the respective opposed side of the vehicle.

10. The vehicle safety system of claim 8, wherein:
the camera is one or both of wiredly and wirelessly connected to the screen; and
the screen is wiredly connected to the turn signal apparatus.

11. The vehicle safety system of claim 10, further including:
a first wire operationally engaging the screen to the turn signal apparatus; and
a second wire operationally engaging the camera to the screen.

12. The vehicle safety system of claim 7, wherein the camera is engaged to a driver's door or a front passenger door of the vehicle.

13. A vehicle safety assembly comprising:
a screen selectively engageable to a sidemirror of a vehicle, such that the screen overlays a portion of and is mounted to the sidemirror, the screen being selectively operationally engageable to a turn signal apparatus of the vehicle, such that the screen is actuated concurrently with the turn signal apparatus, the screen being configured to be engageable to the sidemirror such that the portion of the sidemirror overlaid by the screen is adjacent to a bottom edge of the sidemirror or to a side edge of the sidemirror proximate to an associated opposed side of the vehicle;
a camera selectively engageable to a respective opposed side of the vehicle upon which the sidemirror is positioned, such that the camera is mounted to the vehicle and positioned for capturing a video image of a blind spot of the vehicle, the camera being operationally engaged to the screen, such that the camera is positioned for communicating the video image to the screen, wherein the screen is configured for displaying the video image to a driver of the vehicle, enabling the driver to view objects in the blind spot, the camera being one or both of wiredly and wirelessly connected to the screen, the screen being wiredly connected to the turn signal apparatus, the camera being configured to engage a driver's door or a front passenger door of the vehicle;
a first wire operationally engaging the screen to the turn signal apparatus; and
a second wire operationally engaging the camera to the screen.
